(19) United States
(12) Patent Application Publication
(10) Pub. No.: US 2004/0115599 A1
(43) Pub. Date: Jun. 17, 2004

(54) Method for teaching students how to read

(76) Inventor: Brendan Haggerty, Clearwater, FL (US)

Correspondence Address: NATIONAL IP RIGHTS CENTER, LLC, SCOTT J. FIELDS, ESQ., 550 TOWNSHIP LINE ROAD, SUITE 400, BLUE BELL, PA, 19422, US

(21) Appl. No.: 10/321,775

(22) Filed: Dec. 17, 2002

(51) Int. Cl. G09B 5/00

(52) U.S. Cl. 434/169; 434/178

(57) ABSTRACT

A method for teaching students how to read comprising the use of a plurality of dual sided flip charts wherein one side of a flip chart has a lesson for a student and the other side provides instructions for a tutor; wherein each of said flip charts provides an individual lesson which can assist the student in learning to read;

### FIELD OF THE INVENTION

The present invention is directed to reading methods and apparatus. In particular, the present invention is directed to a system, apparatus and method for assisting individuals in learning how to read. In a more preferred embodiment, the invention is directed to novel system which teaches students how to read.

### BACKGROUND OF THE INVENTION

There have heretofore been a number of patents and prior art technologies directed to systems for assisting students in learning how to read and spell in the English language. American and Canadian schools have taught reading in the English language using a variety of methods. Popular methods used in public schools over the last 45 years have taught children to associate words with pictures or other visual clues, thus replacing the age-old phonics instruction used before that time.

For students, this means committing more words to memory until the task becomes overwhelming. These methods known as “look-say” and “sight methods” have depended in large part on the person's capacity to memorize words.

When a whole language approach is used, students learn a small amount of phonics but seem to miss some of the essential parts. Without understanding the phonics instructions, the child experiences difficulty reading as he or she advances in age and in grade, and is required to add more words to an ever increasing vocabulary.

Many children who read poorly are often labeled dyslexic, a term applied to people who experience specific problems with reading and language. Many dyslexic children are placed in special education classes with an understanding on their part that in some way they are “learning disabled”, “less than normal”, and “defective”. When otherwise normal people perceive themselves as defective or mentally impaired, they feel ashamed. Low self esteem is a common reason why adolescents direct anger outward towards others.

The problem that has originated with popular methods of teaching reading is further complicated when parents realize that the child has developed emotional and/or behavioral problems and seek help from a psychotherapist.

It would be desirable to provide systems and methods for assisting individuals in reading and in learning to read. In addition, it would be particularly desirable to provide a method for assisting students to read and spell in English. A number of patents have been issued directed to reading methods and technologies. U.S. Pat. No. 6,155,834 is directed to a data driven interactive testing method and apparatus for teaching students to read. The invention includes a system that teaches students to sight read using a computer. The term “sight read” means to instantly recognize words without having to sound them out or go through the process such as explaining the definition of a word. The invention incorporates a computer to systematically and continuously adjust the requirements for word perception and recognition based on characteristics and ongoing responses of the individual students.

U.S. Pat. Nos. 5,147,205; 4,245,405 similarly are directed to computer based systems for teaching reading.

U.S. Pat. No. 3,279,093 discloses a method employing audio visual aids for teaching reading skills. The Taylor method employs the use of screen in which words are played over loud speakers.

U.S. Pat. Nos. 2,867,917 and 3,170,245 respectively, disclose devices which facilitate the teaching of reading skills.

The prior art has further facilitated systems which teach reading through the use of methods incorporating wagering chips, having a timer and cards bearing an alphabet learning indicia, such as U.S. Pat. No. 5,951,297.

Finally, U.S. Pat. No. 5,057,020 is a reading machine and method for teaching reading in which words are augmented with symbols and numbers to facilitate learning how to speak each sound with each syllable in a correct sequence.

While there are clearly a number of prior art reading systems, none of the systems of the prior art provide an easy to use system whereby students can learn the system and impart knowledge to others.

It is this a principal object of the present invention to provide a system which facilitates reading both by children and by individuals who do not speak English as a first language;

It is a further object of the present invention to provide a novel teaching and presentation system whereby two individuals in a progressive fashion, can teach each other how to read;

It is still a further object of the present invention whereby individuals and students can dramatically increase their reading ability.

It is still a further object of the present invention to provide a novel presentation method for using the teaching system of the present invention. These and other objects of the present invention would become apparent from the detailed description which follows.

### BRIEF DESCRIPTION OF THE FIGURES

The present invention is described with reference to the enclosed figures.

FIG. 1 is an uprightable presentation system in accordance with the present invention.

FIG. 2 illustrates a computer based system in accordance with the present invention.

FIGS. 3 through 19 illustrate basic teaching features and techniques of the present invention.

### DETAILED DESCRIPTION

The present invention comprises a set of booklets in a first embodiment in which the student sits across from the teacher. The books are set up such that a teacher is provided with teaching information relevant to the information provided to the student. In particular, the basic thrust of the invention is for a student to learn to sound out and understand words at the same time.

Initially, the student will read words out loud, at first these words will be simple. Later the words will become gradually harder. The student needs to have a purpose to read. The best way to motivate the student to learn to read is by making reading fun.

Before beginning, it is critical that the student be ready to learn. Thus teachers should speak with the student for a few minutes and establish friendly communication. If a student wears glasses, it is important to make sure that the student has them on and that he or she is not tired or hungry. The student should be prompted to establish meaningful targets. The student should not be forced to do more than he or she wants.

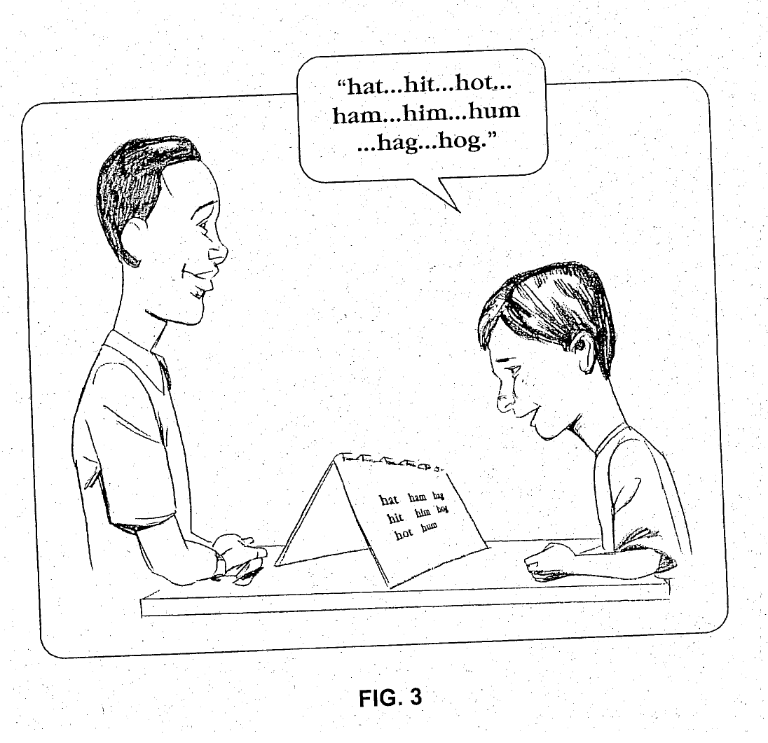

The program of the present invention comprise twenty lessons. Each lesson teaches a new skill. Begin with Lesson No. 1 with the student even if they seem more advanced. By beginning on Lesson No. 1, the teacher insures that the student does not have any gaps in his knowledge caused in the system. Instructions are maintained in quotation marks 12. Parenthesis 14 are used when writing to set apart words that explain or give more information. Italic information provides information that should be asked of the student. The student should read from the top of each column and not across. As shown in FIG. 3, the words are put in columns so that students can easily see the difference and similarities between words. It is critical that the student understands the teacher and also understands each step before moving on to the next steps. Instructions need to be followed in order.

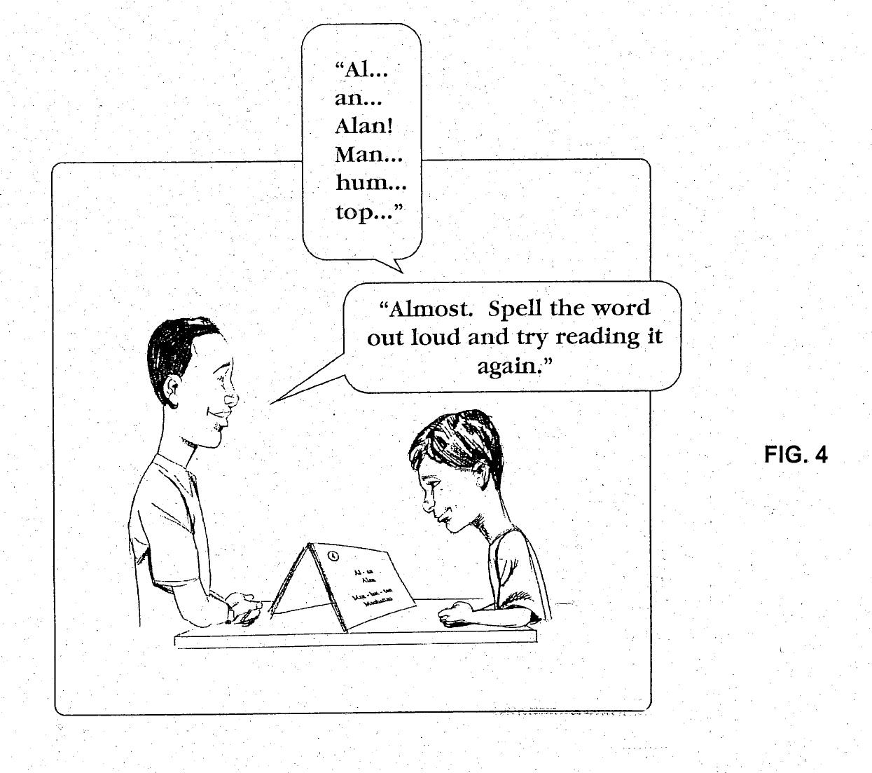

The teacher should ask the student to do the instructions given in a first set of quotation marks. Once the student has accomplished those instructions, it is necessary to move on to the instructions given in the next quotation marks, etc. With a partner, it is important to practice correcting a misread word by having a student spell the word out and then reading it again. As shown in FIG. 4, if a student is unable to read a word after spelling it, the student should be asked to “sound it out.” This means to start at the beginning of the word and pronounce the sounds of the letters until the whole word has been said.

If the student is unable to read a word after spelling it out and trying to sound it out, must tell the student what it is and make sure he or she understands what it means, then have the student spell the word out and read it.

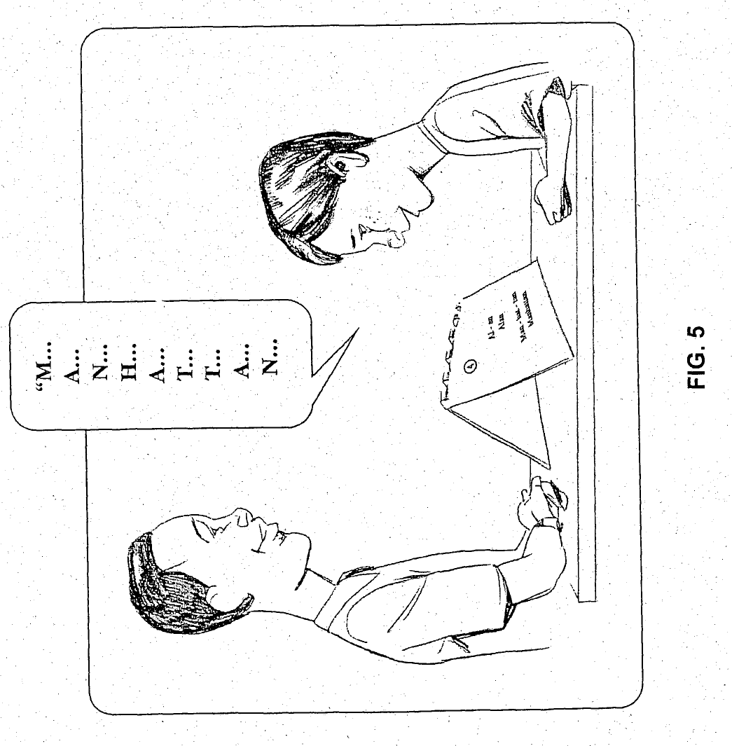

As shown in FIG. 5, the system is further directed to helping students with multi-syllable words. Syllables are parts of words and multi means more than one. Longer words typically have more syllables. For example, the word cat has one syllable and the word Mississippi has four syllables. It is critical that students learn how to read words with two or more syllables. For this reason, the student will be learning big multi-syllable words right away in the program. Big words are typically written syllable-by-syllable the first time they appear, such as man-hat-tan- for Manhattan.

If the student makes a mistake when reading a multi-syllable word, it is handled in the same way a small word is handled. The first step is to have the student spell the word out and try reading again.

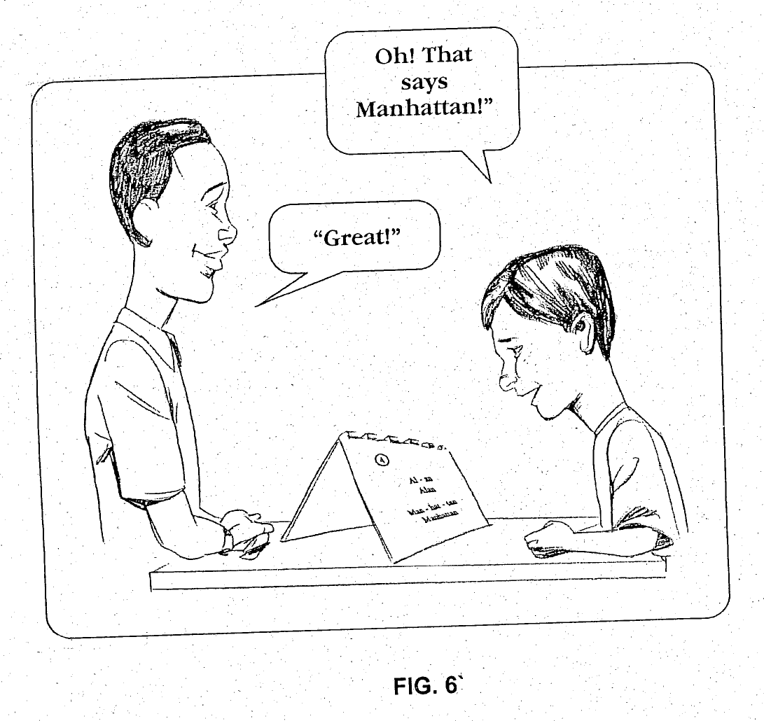

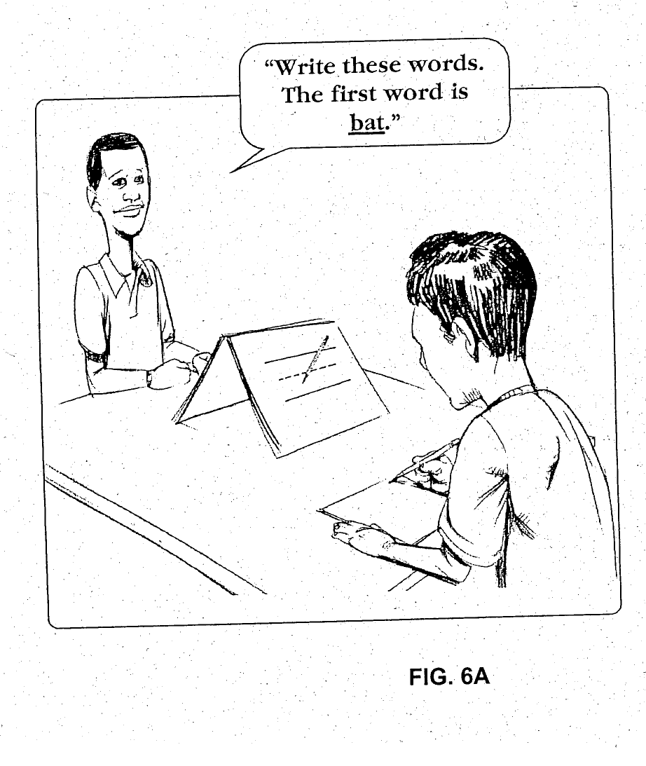

As shown in FIGS. 6 and 6a, the system also teaches students how to spell. The student is provided with a spelling notebook used for the words and sentences he or she would be writing. The teacher will ask the student to spell words many times while going through each lesson packet. The student should try one word per line in his or her notebook in the neatest writing possible. With a partner, the student should be given spelling words from a flip chart. The student should then show the teacher how they are written. If the student misspells the word the teacher should explain what the word means.

If the student doesn't understand the misspelled word, the teacher should show the student the word in the dictionary as shown in FIG. 6A. Once a teacher makes sure that the student knows what the word means, the student should then be shown the correct spelling. The student should be forced to write the word five times for practice. The student should then say the letters of the word out loud as he or she is writing, and then speaks the word. Simple handwriting mistakes should be corrected before moving on to the next step. Each spelling word is printed on the tutor side of the chart. This should be shown to the student when correcting handwriting.

Comprehension, which is critical, in reading means to understand. To teach comprehension, it is necessary to make sure that the student learns definitions of the words he is reading and hearing. This is done by picking out some of the words in a lesson and asking the student to interpret them.

Lesson Nos. 2 through 11 of the present invention provide a special dictionary. The dictionary contains pictures of the words used in those lessons. Use of the dictionary helps the students understand the words. The students may just need to look at the picture to get the meaning or the teacher may need to tell the student some additional information to make sure that the word is understood. For Lesson Nos. 12 through 20 in the invention, the user uses a standard English dictionary to define words with a student. With a partner, it is necessary to practice making sure that the student understands words from each lesson. Some of the steps in the program ask a student to make up a sentence for each word on a page he is reading. Sometimes a student may have a hard time making up such a sentence. In this case, the tutor should make sure that the student understands the word and should help the student by making up sentences himself or herself so that the student can see how this is done.

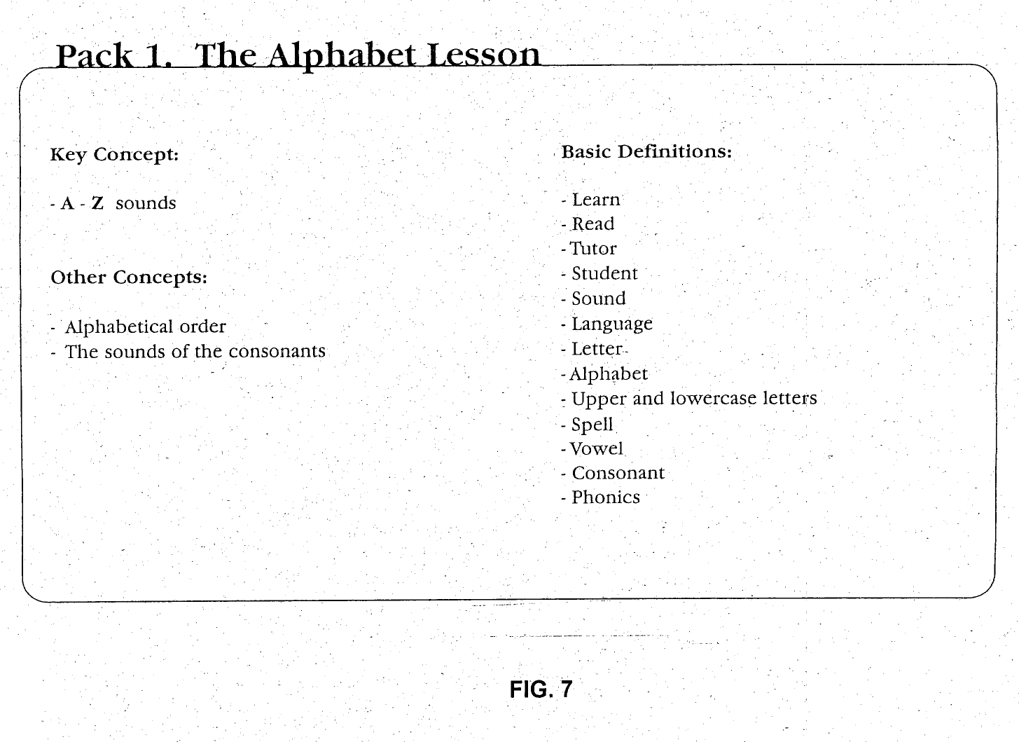

As shown in FIG. 7, the invention incorporates a number of reminding pictures including reminders acknowledging for the student to say one word at a time, to make sure that the student understands various words and to smile and have fun.

The present invention can be utilized in recreation centers or schools where there are several pairs of tutors and students. In such a setting, a supervisor may supervise a number of students within the materials, a special group or picture will identify places where a supervisor may be required.

The present invention incorporates 20 lessons in one embodiment. Lesson No. 1 is entitled The Alphabet Lesson (FIG. 7); Lesson No. 2 is The A Lesson; The U Lesson; The E Lesson; The O Lesson; The Blend Lesson; The End Lesson; The ING Lesson; The Two Continents/One Sound Lesson; The Silent E Lesson; The Special Vowel Lesson; The R Team Lesson; The Silent Letters Lessons; The Contractions Lesson; The Silent Letters and Soft Letters Lesson; The Advanced Syllable Lesson; and The Parts of Speech Plurals Lesson. The purpose of these lessons is to facilitate the ability of the student to read by the completion of the twentieth lesson.

The first packet is the alphabet lesson directed to the learning of the A through Z sounds, alphabet order and sounds of consonants;

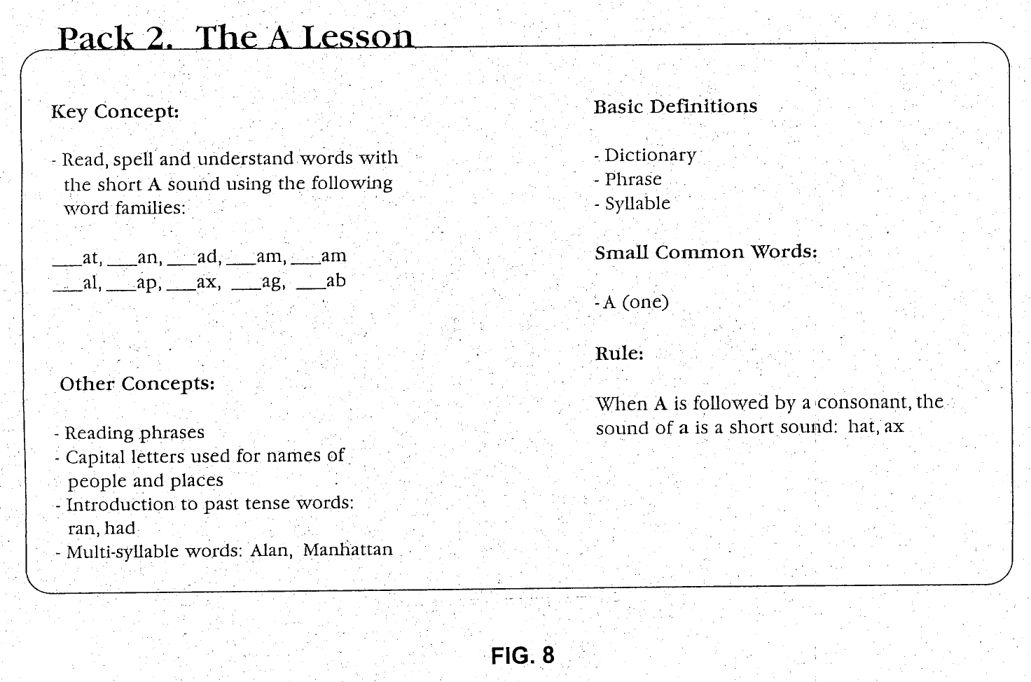

The second lesson, called the A Lesson (FIG. 8), is directed to reading, spelling and understanding words with the short A sound using the following words families: AT, AN, AD, AM, AL, AP, AX, AG and AB. Other concepts in this packet including reading phrases, capital letters used for names of people and places; introduction to past tense words and multi-syllable words involving the short A sound.

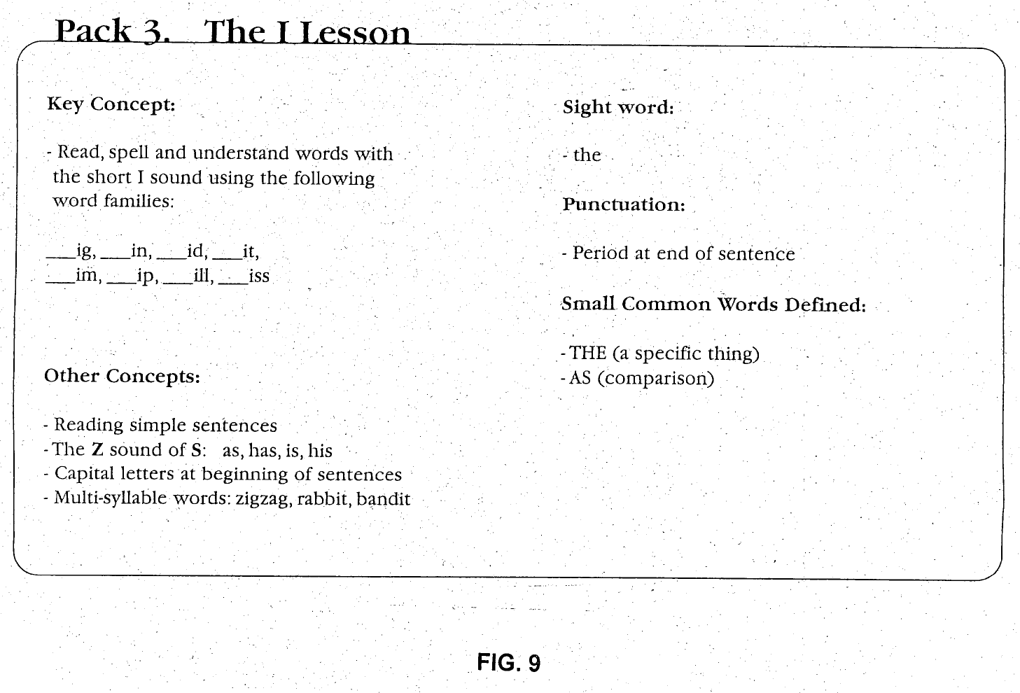

Lesson No. 3 (FIG. 9) provides the short spell and understanding words with the short “i” sound using such word families as IG, IN, ID, IT, M, IP, ILL and ISS. The concepts also covered include reading simple sentences. The “v” sound of “s” such as as, has, is, and his. Capital letters at the beginning of sentences and multi-syllable words such as “zigzag”, “rabbit” and “bandit”.

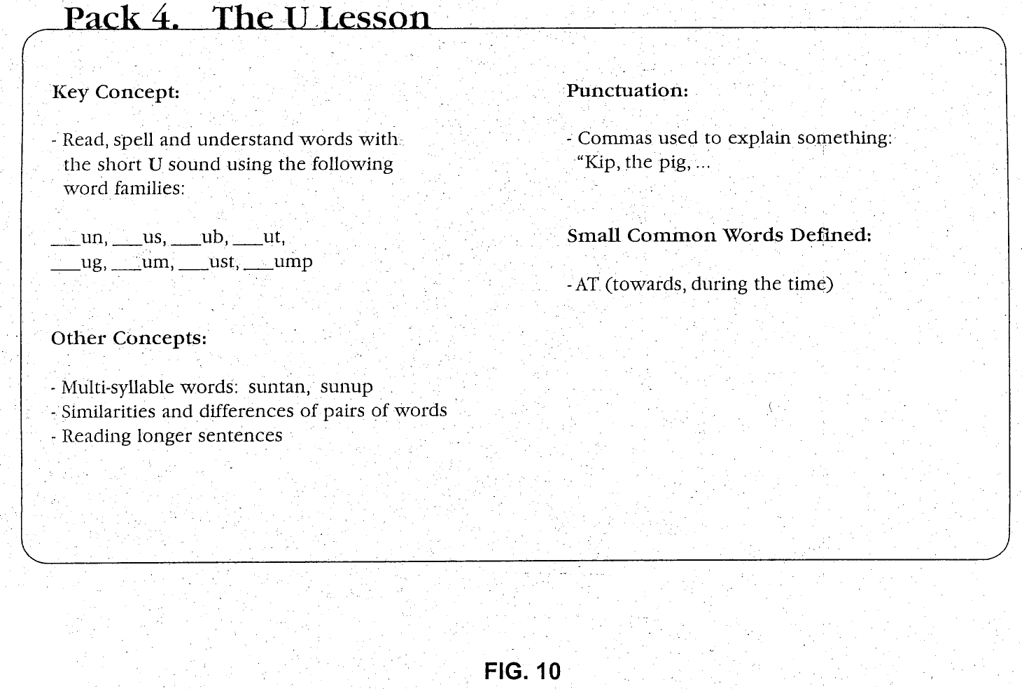

Lesson No. 4 is the “U” (FIG. 10) lesson and is directed to reading, spelling and understanding words with the short “u” sound using the following word families: UN, US, UB, BUT, UG, UM, UST and UMP. Multiple syllable words in this packet include suntan and sunup and each student is taught similarities and differences of different pairs of words and the need to read longer sentences.

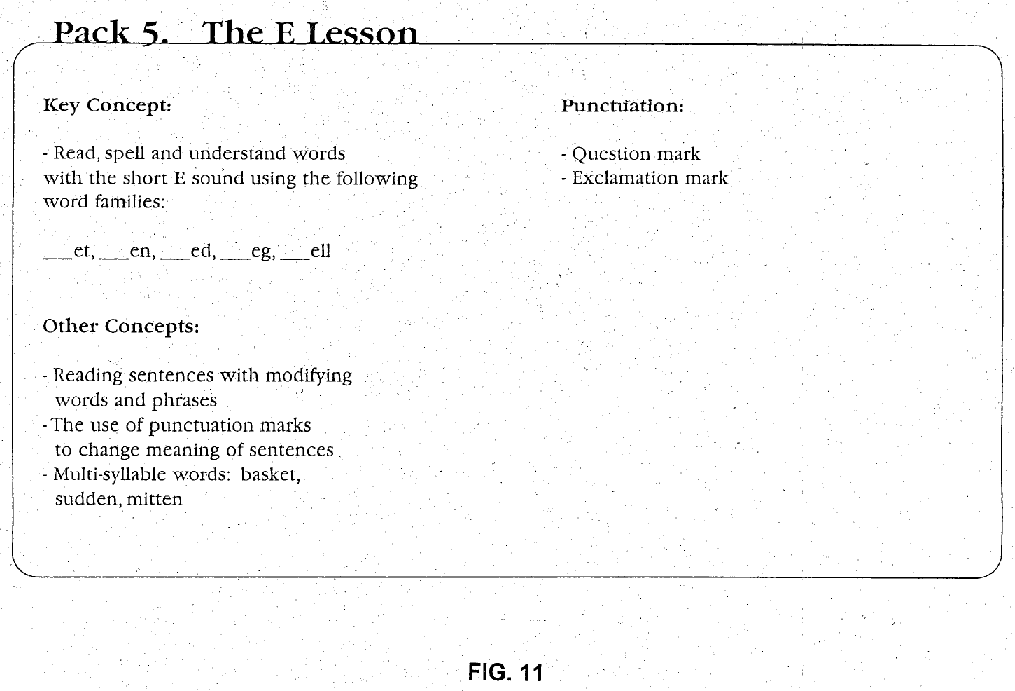

Lesson No. 5 (FIG. 11) covers the short “e” sound using such word families as ET, EN, ED, EG, ELL. The student further reads sentences with modifying words and phrases, the use of punctuation marks to change the meaning of sentences and multi-syllable words such as basket, sudden and mitten.

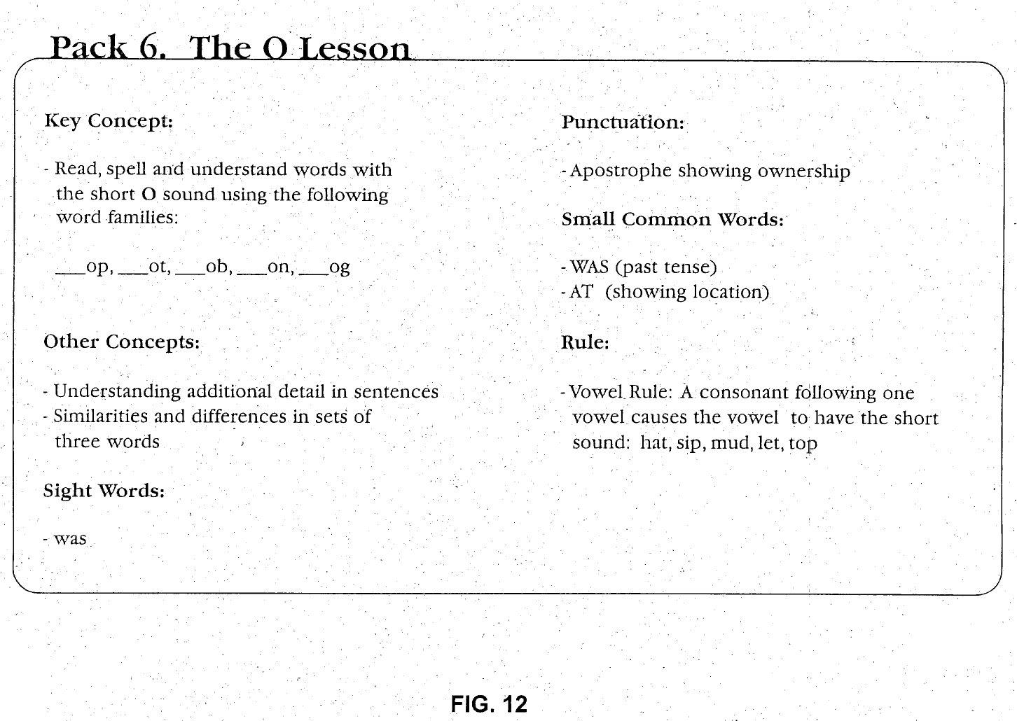

Lesson No. 6 (FIG. 12) is directed to the short “o” sound using such word families AS OP, OT, OB, ON and OG. The student is further instructed in understanding additional detail in sentences and the similarities in different sets of three words.

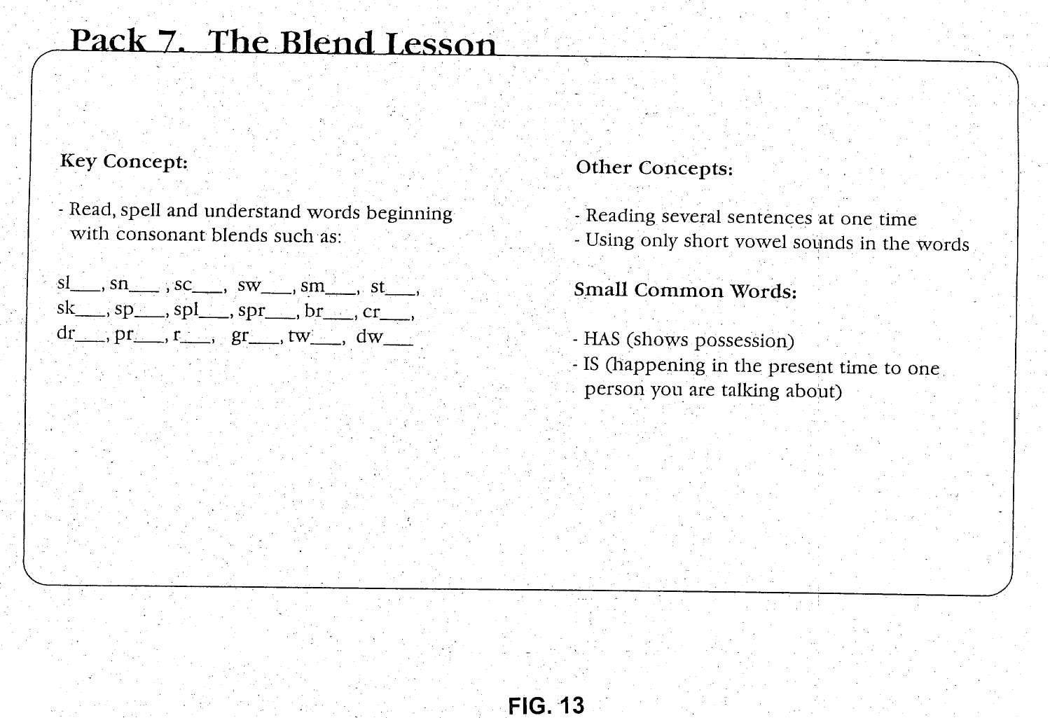

Lesson No. 7 (FIG. 13) is the blend lesson is directed to reading, spelling and understanding words beginning with consonant blends such as SL, SN, SC, SW, SK, SPL, ST, SPR, BR, CR, DR, PR, R, GR, TW and DW. The student is further drilled in reading several sentences at one time and using only short vowel sounds in the words. The lesson incorporates more common words such as “has” and “is”.

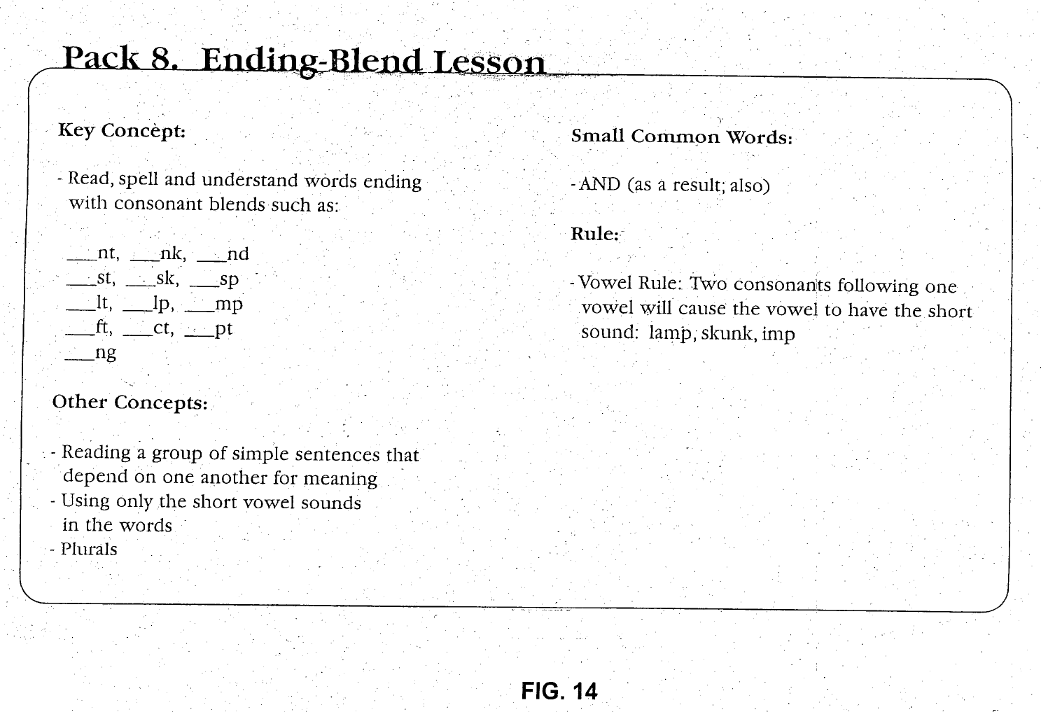

Lesson No. 8 (FIG. 14) instructs the student in ending blend words, in which the student reads, spells and understand words ending with consonant blends such as NT, NK, ND, ST, SK, SP, LT, LP, MP, FT, CT, PT, and NG. In this lesson, the student is instructed to read a group of simple sentences that depend on one another for meaning and use only the short vowel sounds in the words as well as plurals.

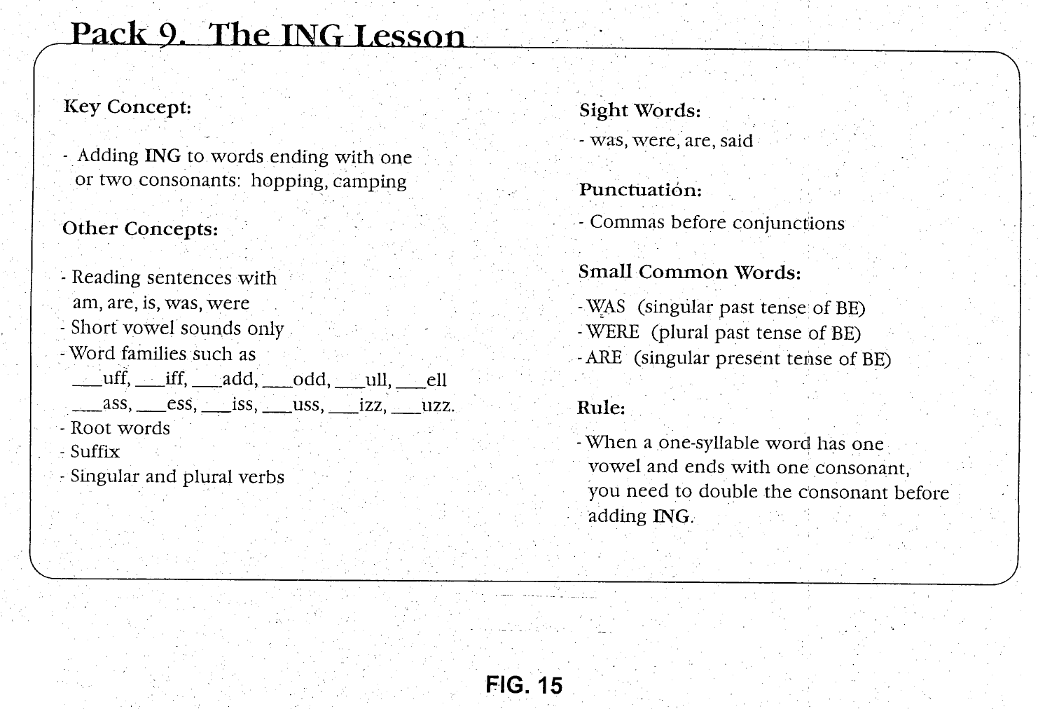

Lesson No. 9 (FIG. 15) is the “ing” lesson in which the “ing” (gerand) are added to the end of one or two consonants such as “hoping” or “camping”. The other concepts taught in this lesson include reading sentences with am, are, is, and were. Short vowel sounds and word families such as OF, IF, ADD, ODD, ULL, ELL, ASS, IS, and UZZ. The student further learns root words, suffixes, and singular and plural verbs.

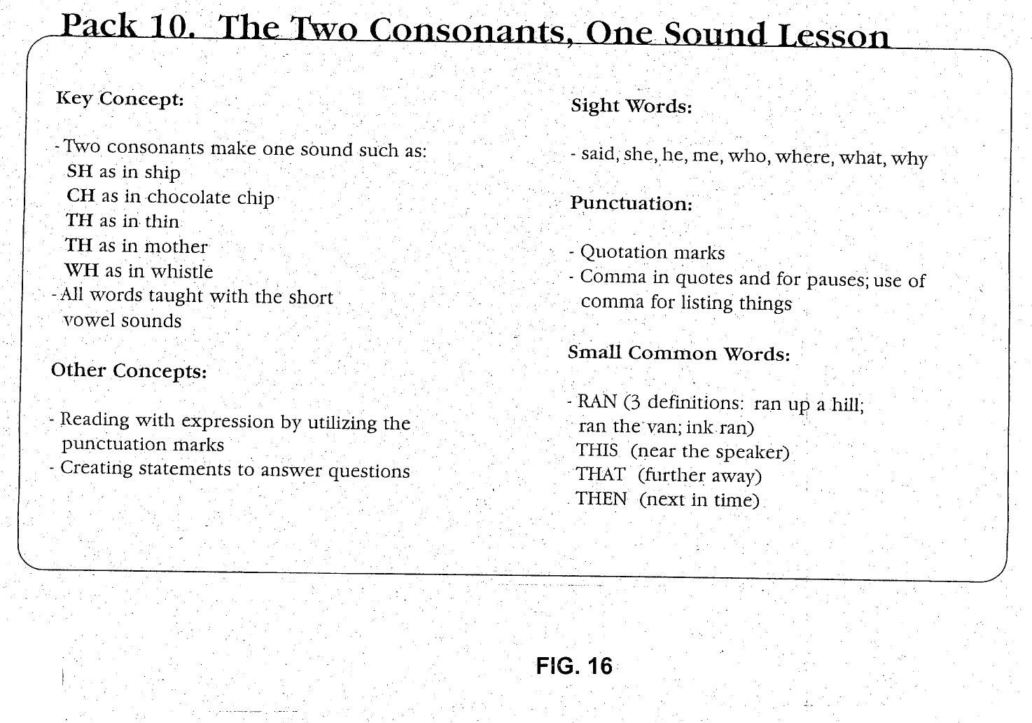

Lesson No. 10 (FIG. 16) is directed to words teaching students in the use of two consonants, i.e., one sound covers two consonants that produce one sound. Such consonants make up one sound such as sh, and ship, ch as in chocolate chip, th as in thin, th as in mother, wh as in whistle. All words are taught with the short vowel sounds. The student is further drilled in reading with expression by utilizing punctuation marks and creating statements to answer questions.

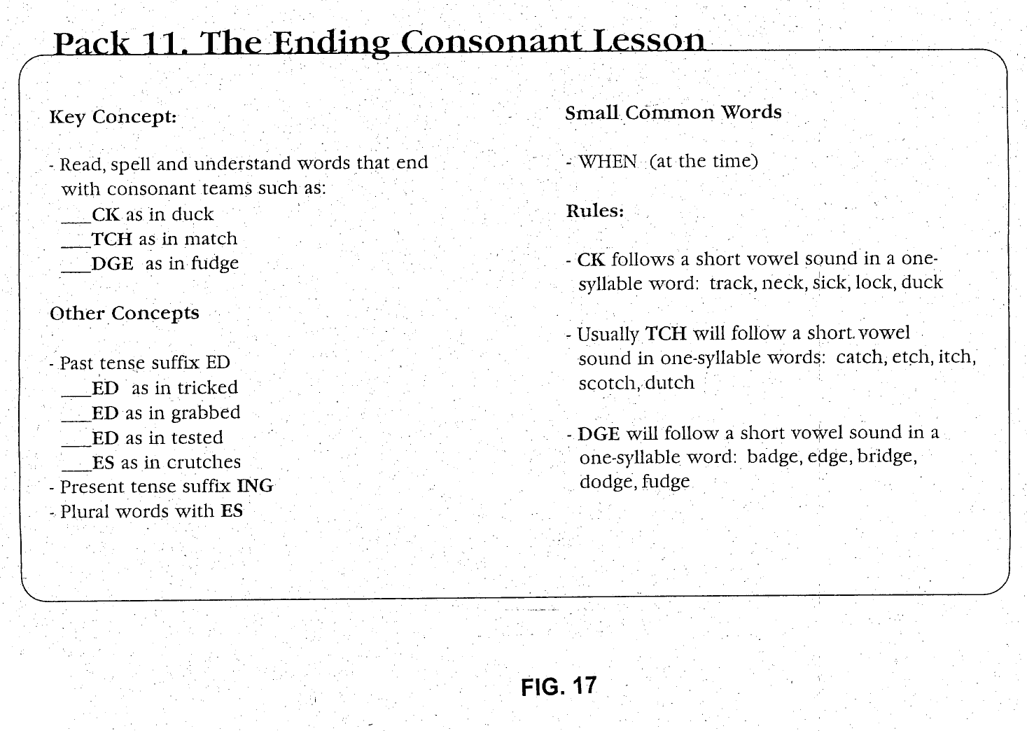

Lesson No. 11 (FIG. 17) the student covers the ending consonants such as ck, as in duck, tch as in match and dge as in fudge. This lesson further covers the past tense suffix ed as in tricked, grabbed, tested and crutches. The present tense suffix ing and polar words with es.

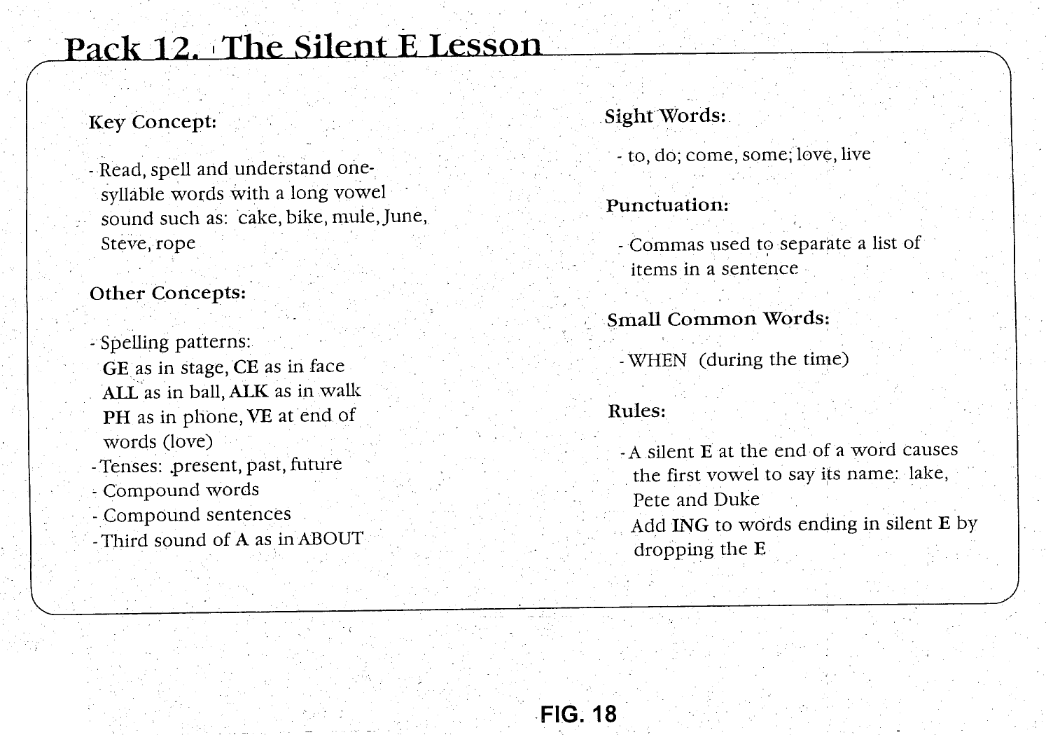

Lesson No. 12 (FIG. 18) covers the silent “e” lesson. This lesson is directed to reading, spelling, and understanding one syllable words with a long vowel such as cake, bike, mule, june, steve and rope. In each of these, the “e” is silent. The student is further drilled in spelling patters such as ge as in stage, ce as in face, ph as in phone and ve at the end of words such as love. The student is also in tenses, (present, past and future) compound words, compound sentences and the third sound of “a” as in about.

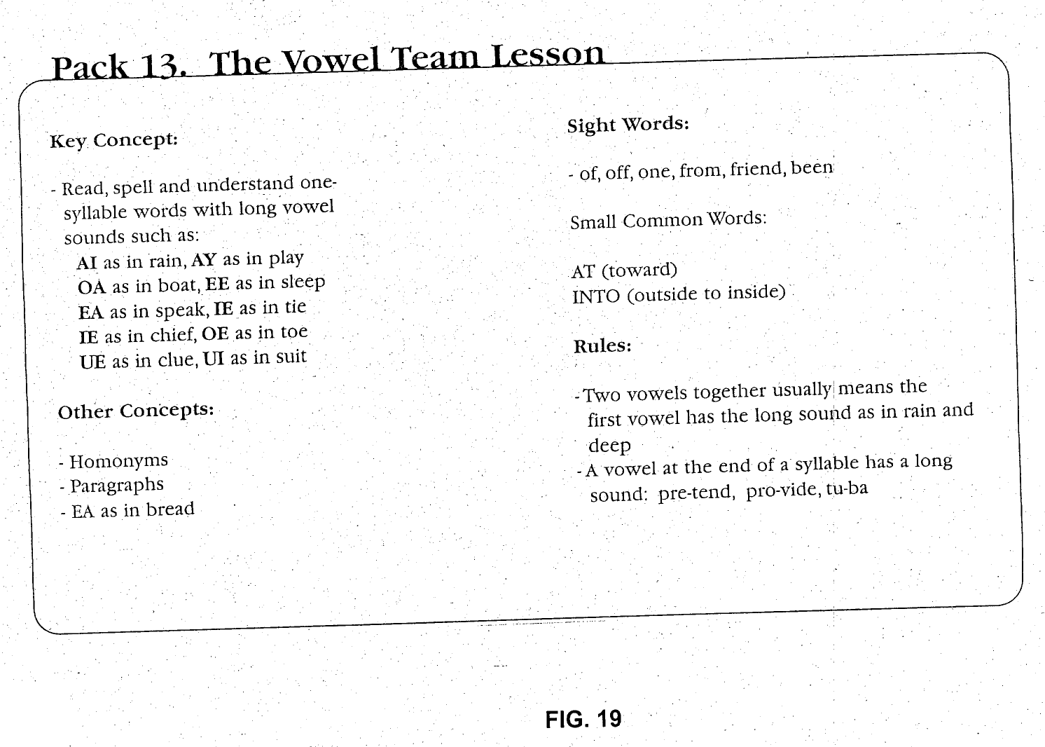

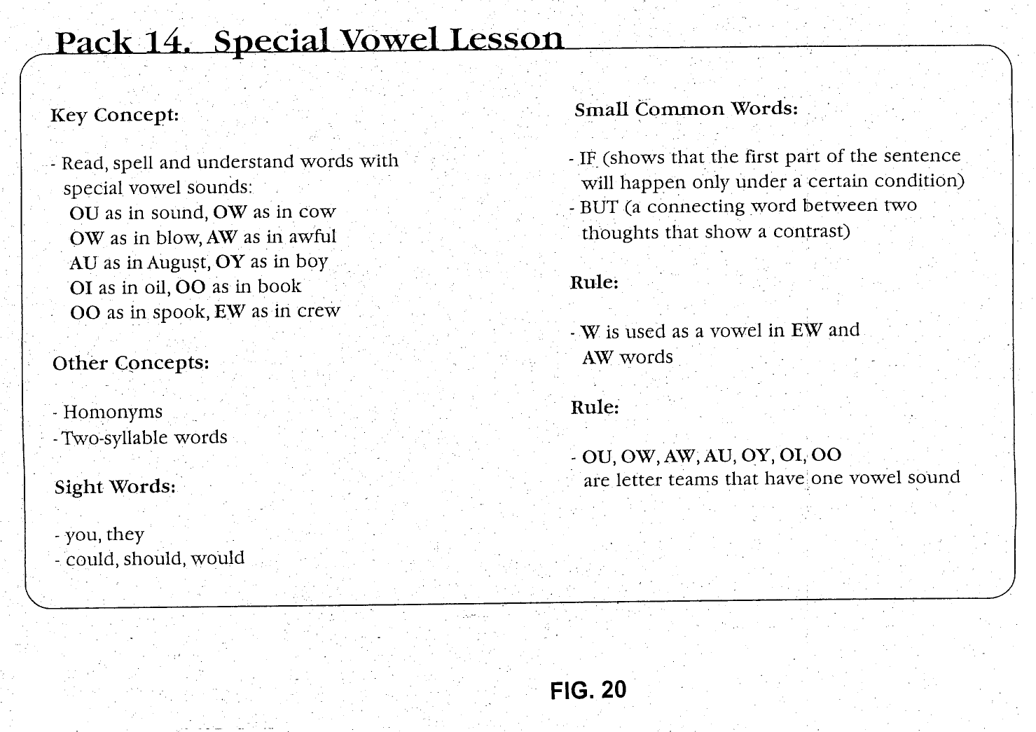

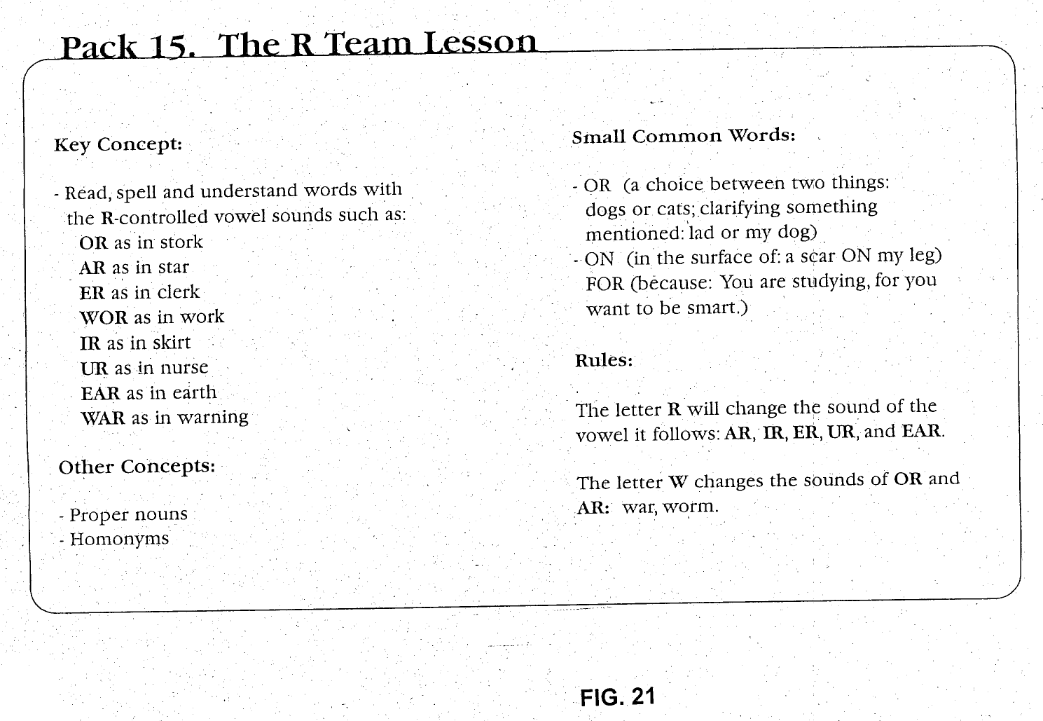

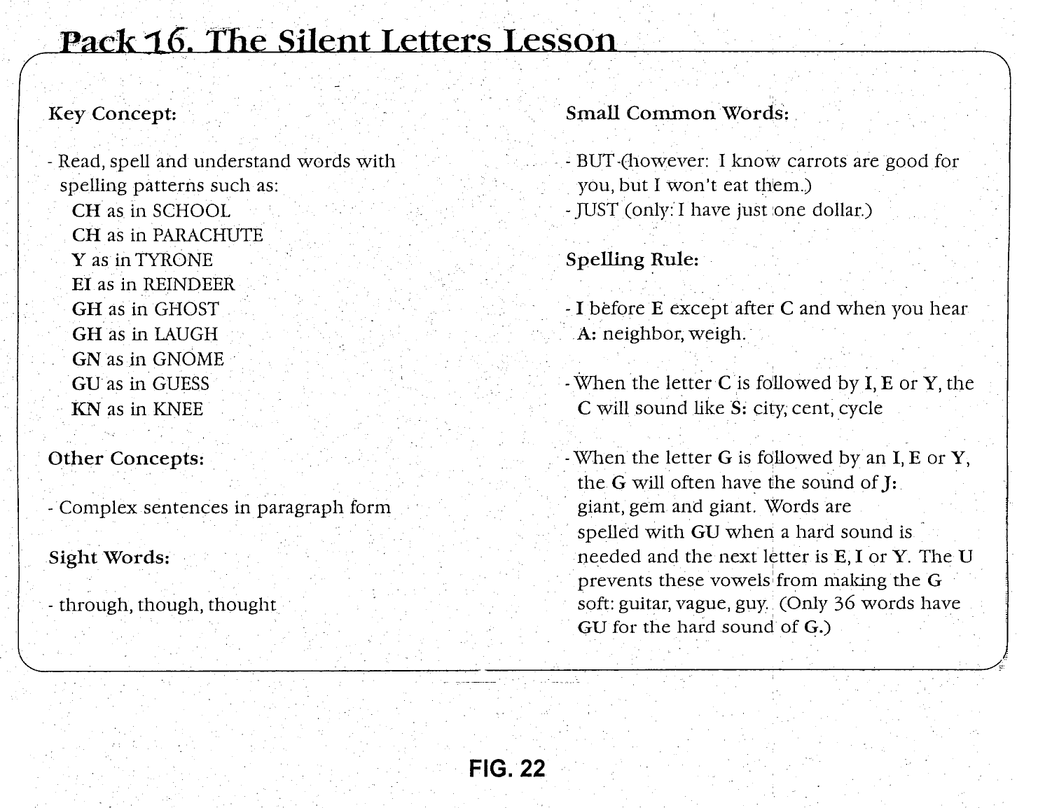

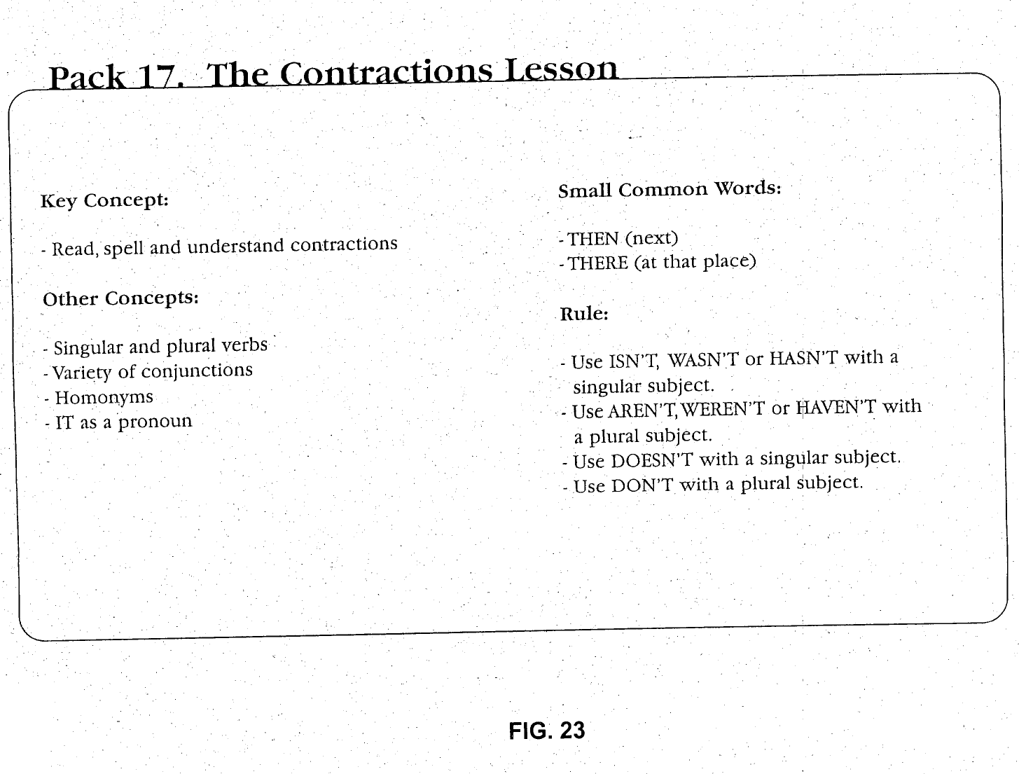

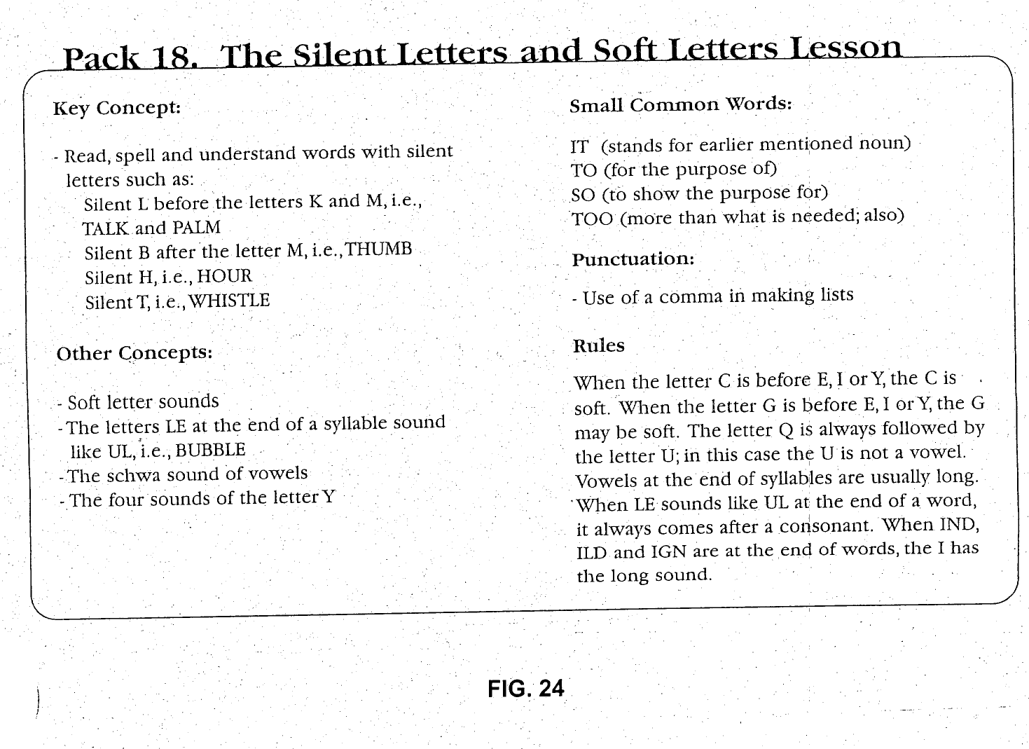

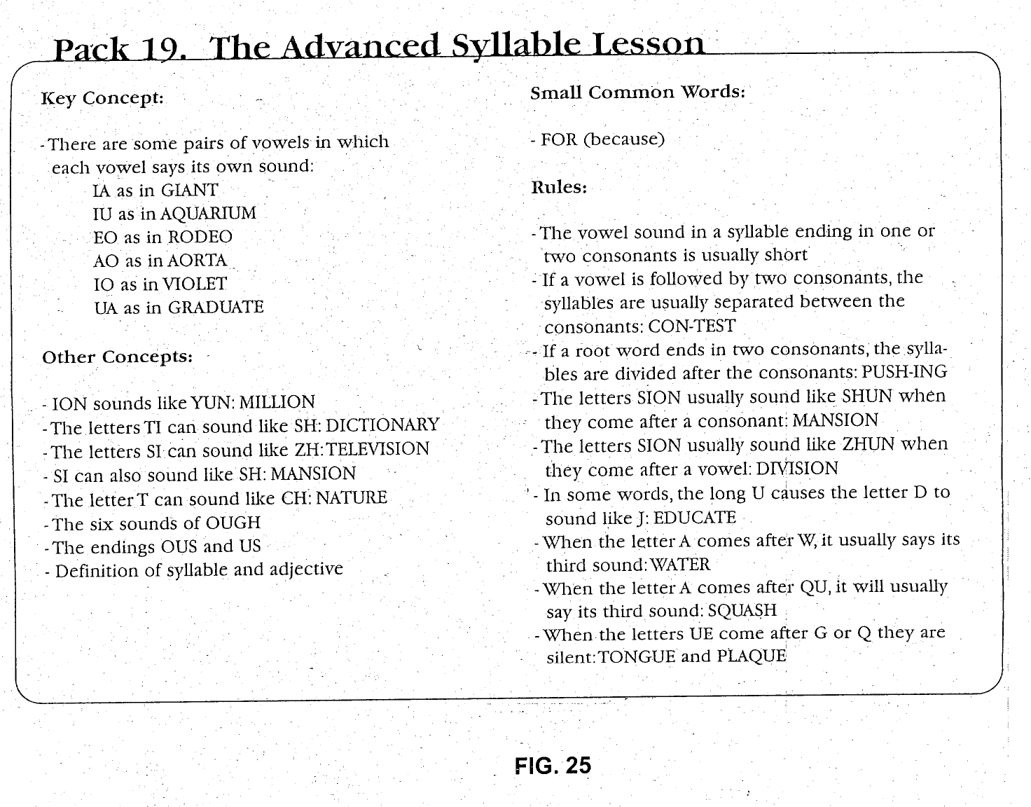

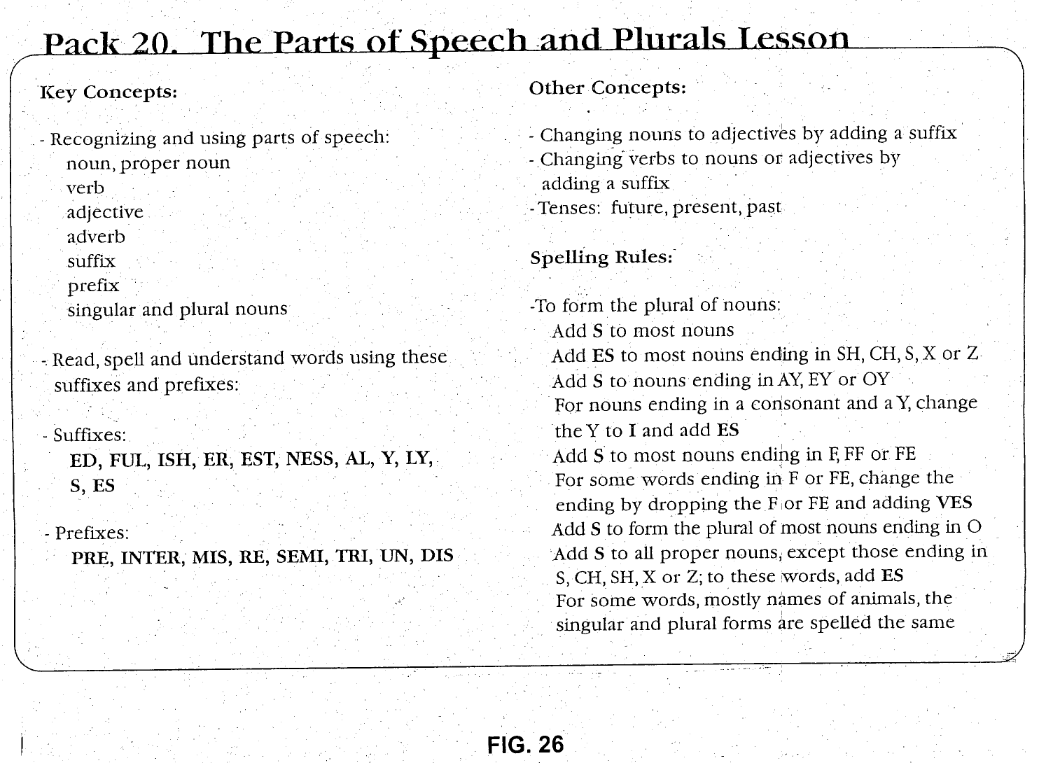

Lesson No. 13 (FIG. 19) is the vowel team lesson which draws the student in reading, spelling and understanding one syllable words with long vowel sounds such as ai as in rain, ay as in play, oa as in boat, ee as in sleep, ea as in speak, ie as in pie, ie as in chief, oe as in toe, ue as in clue and ui as in suit. The student is further drilled in homonyms, paragraphs and the use of ea as in bread.

In Lesson No. 14 (FIG. 20) the student covers special vowels. These are words with special vowel sounds such as ou as in sound, ow as in cow, ow as in blow, aw as in awful, au as in August, oy as in boy, oi as in boil, oo as in book, oo as in spook and ew as in crew. The student further learns homonyms and two syllable words.

Lesson No. 15 (FIG. ) is the so-called “R” team lesson in which the student is drilled in spelling, reading and understanding words with the “r” control vowel sound such as or “or” in “stork”, “ar” as in “star”, “er” as in “clerk”, “wor” as in “work”, “ir” as in “skirt”, “ur” as in “nurse”, “ear” as in “earth”, and “war” as in “warning”. The student is also drilled in the use of proper nouns and homonyms.

Lesson No. 16 (FIG. 22) covers the silent letters. The student is drilled in reading, spelling and understanding words with spelling patterns such as “ch” as in “school”, “ch” as in “parachute”, “y” as in “Tyrone”, “ei” as in “reindeer”, “gh” as in “ghost”, “gh” as in “laugh”, “gn” as in “gnome”, “gu” as in “guess” and “kn” as in “knee”. The student further learns complex sentences in paragraph form and the use of words such as throw and fought. The lesson further covers special spelling rules such as “i” before “e” except after “c” and when the long “a” is pronounced as in “neighbor” or “ray”.

Lesson No. 17 (FIG. 23) covers contractions and the student is drilled on reading, spelling and understanding contractions. This lesson further covers singular and plural verbs, a variety of conjunctions, homonyms and it as a pronoun. Contractions cover such words as isn't, wasn't, hasn't, wouldn't, couldn't, etc.

Lesson No. 18 (FIG. 24) covers silent letters and soft letters. In this lesson, the student is drilled in reading, spelling and understanding words with a silent letter including the silent “I” before the letters “k” and “m”, i.e. talk and palm; the silent “b” after the letter “m” as in thumb, the silent “h” in hour, and the silent “t” is whistle. The student is further drilled in soft letter sounds, the letters “le” at the end of a syllable sound such as bubble, the “schwa” sound of vowels and the four sounds of the letter “y”.

In the advanced syllable Lesson 19 (FIG. 25) the student is drilled that there are some pairs of vowels in which each vowel has its own sound such as “ia” in “giant”, “iu” as in “aquarium”, “eo” as in “rodeo”, “ao” as in “aorta”, “io” as in “violet”, and “ua” as in “graduate”. The student further learns that ion sounds like “yon” and “million” and that the letters “ti” sound like “sh” in dictionary. That the letters “si” can sound like “zh” as in “television” and “si” can also sound like “sh” in “mansion”; that the letter “t” can sound like “ch” in “nature”. The six sounds of “ough” are covered and the endings “ous” and us are further covered in this lesson.

In the final lesson (FIG. 26) the student covers the parts of speech in plurals. The key concepts taught to the student include recognizing and using parts of speech such as nouns, proper nouns, verbs, adjectives, adverbs, suffixes, prefixes and singular and plural nouns. The student is drilled in reading, spelling and understanding words using these suffices and prefixes. The suffixes include “ed”, “ful”, “sh”, “er”, “est”, “ness”, “al”, “y”, “ly”, “s” and “es”. Prefixes include “pre”, “inter”, “mis”, “re”, “semi”, “tri”, “un”, and “dis”. This lesson further covers changing nouns to adjectives by adding a suffix; changing verbs to nouns or adjectives by adding a suffix and the future past and present tense.

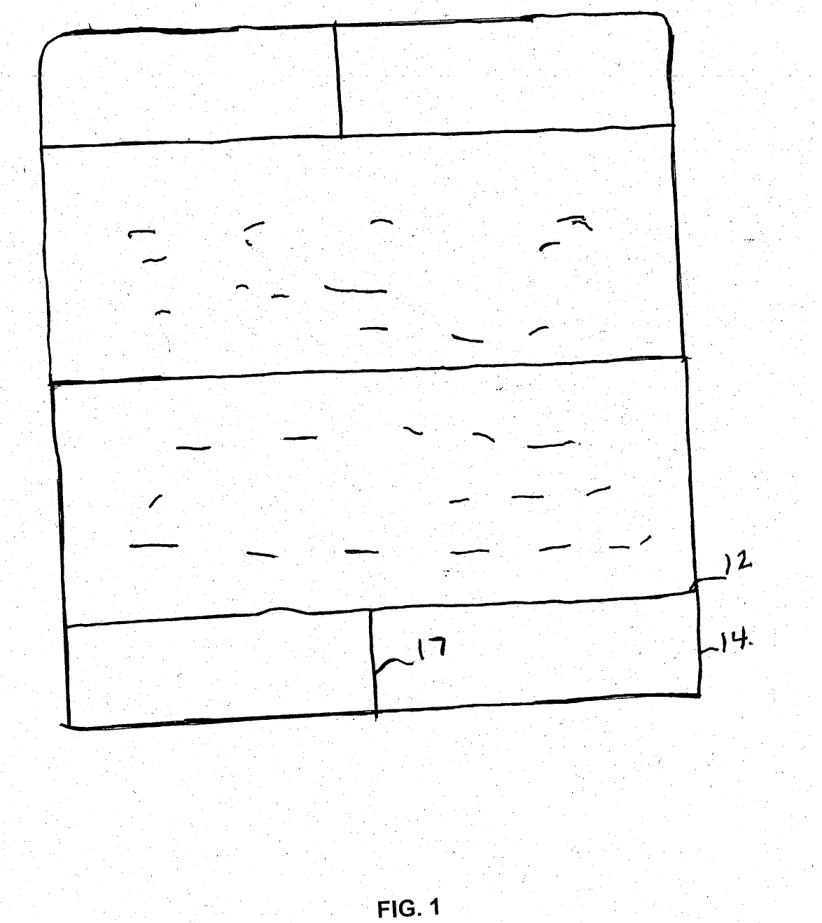

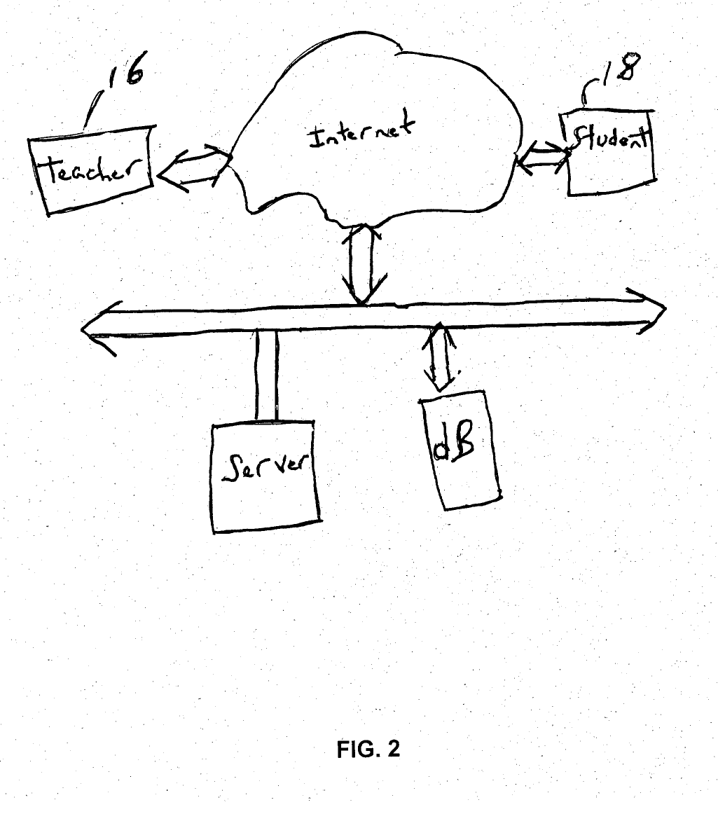

Referring now to FIG. 1 of the present invention, in one embodiment, the present invention is designed and intended to be carried by means of a series of uprightable booklets. The booklets are designed to be supported by end means 12 which extend outward from the end of the cover 14 and which interlock via slits 17. In this manner, the student and tutor can sit directly across from each other and the tutor can be provided with instruction, tips and clues to assist the student in learning. It is to be appreciated that the teachings of the present invention are immediately applicable to the present invention. As shown in FIG. 2, the present invention can exist in the context of a computer system. In this system, the student can interface with a remote teacher and also with computers 16, 18. The system can provide a number of interactive systems including voice recognition and audio visual interface to assist with education.

It is to be appreciated that the present invention is described in reference to the enclosed figures and detailed descriptions. Other embodiments of the present invention can be gleamed from the claims appended hereto.

1. A method for teaching students how to read comprising the use of a plurality of dual sided flip charts wherein one side of a flip chart has a lesson for students and the other side provides instructions for a tutor; and
wherein each of said flip charts provides an individual lesson which can assist the student in learning to read.

2. An apparatus for assisting students to read comprising at least one flip chart booklet wherein one side of a page provides an instruction to a student and a facing page of the next page provides a set of instructions or tips for a tutor; and
folding support means for supporting the lesson such that the student and tutor can face each other with each being presented with a related instruction.

3. The system of claim 2 wherein said apparatus for supporting the booklet comprises a plurality of individual flaps which stand sideways and lock the book in an upright position.
